(19) United States
(12) Patent Application Publication
(10) Pub. No.: US 2009/0291608 A1
(43) Pub. Date: Nov. 26, 2009

(54) ELECTROMAGNETIC WAVE SHIELDING GASKET HAVING ELASTICITY AND ADHESIVENESS

(76) Inventors: Jeongwan Choi, Kyonggi-do (KR); Hun Jeong, Gyeonggi-do (KR); Won-Sik Kim, Kyonggi-do (KR)

Correspondence Address: 3M INNOVATIVE PROPERTIES COMPANY, PO BOX 33427, ST. PAUL, MN, 55133-3427, US

(21) Appl. No.: 12/305,005

(22) PCT Filed: Jun. 29, 2007
(86) PCT No.: PCT/US07/72434

§ 371 Date: Dec. 16, 2008

(30) Foreign Application Priority Data
Jul. 4, 2006 (KR) 10-2006-0062468

(51) Int. Cl. H01B 1/12; H01B 1/22; H01B 1/24; B32B 27/12; B32B 15/08; B32B 5/16; B32B 37/00; C08F 2/48

(52) U.S. Cl. 442/394; 252/500; 252/514; 252/512; 252/513; 252/521.3; 252/503; 428/339; 428/337; 428/221; 428/457; 428/323; 156/275.5; 427/508

(57) ABSTRACT

Disclosed is a gasket having electric and adhesive properties as well as electromagnetic wave shielding functions and a method for manufacturing the same. The gasket includes an adhesive polymer sheet having electrical conductivity and being disposed in the longitudinal and transverse directions of an electroconductive substrate, so that the gasket has impact and vibration absorbing properties in addition to an adhesive property.

### BACKGROUND OF THE INVENTION

1. Field of the Invention

The present invention relates to an electromagnetic wave shielding gasket having elastic and adhesive properties and a method for manufacturing the same. More particularly, the present invention relates to an electromagnetic wave shielding gasket, in which an adhesive polymer sheet having electrical conductivity is disposed in the longitudinal and transverse directions of an electroconductive substrate, so that the electromagnetic wave shielding gasket has impact and vibration absorbing properties as well as an adhesive property.

2. Description of the Prior Art

Various harmful electronic waves or electromagnetic waves generated from circuits of various electronic appliances may cause malfunction of peripheral electronic devices or components thereof, degrade performance of the electronic devices, deteriorate the image while generating noise, reduce the life span of the electronic devices or components thereof, and cause defect to electronic products. In order to shield such harmful electronic waves and electromagnetic waves, various electronic wave and electromagnetic wave shielding materials have been developed. For example, such materials include metal plates, metal plated fabrics, conductive paints, conductive tapes or polymeric elastomers to which conductivity is imparted.

Currently, gaskets are being used in order to shield the electronic/electromagnetic wave. However, such a gasket must not only have electronic wave and electromagnetic wave shielding functions, but also have elasticity so as to tightly assemble various electronic components of the electronic device and to absorb impact and vibration.

For this reason, a polymeric elastomer sheet, to which conductivity is imparted, is generally used as the gasket.

For instance, in order to use polyurethane foam as an electromagnetic wave shielding gasket by imparting electroconductivity into the polyurethane foam, fabrics or plastic films can be laminated onto both surfaces of the polyurethane foam (see, U.S. Pat. Nos. 3,755,212, 3,863,879, 4,216,177 and 5,859,081). The polyurethane foam provided with the fabrics or plastic films is an electromagnetic wave shielding material having surface conductivity only, with little volume conductivity, so the electromagnetic wave shielding material is mainly used only when surface conductivity is necessary.

Conventionally, fine powder of conductive carbon black, graphite, gold, silver, copper, nickel or aluminum is directly applied to the polymeric elastomer in order to impart vertical volume conductivity into the polymeric elastomer.

That is, when fabricating the polymeric elastomer, fine metallic powder of conductive carbon black, graphite, gold, silver, copper, nickel or aluminum is uniformly distributed in the polymeric elastomer as conductive fillers. However, in order to impart conductivity to the polymeric elastomer using the conductive fillers, particles of the conductive fillers must form a consecutive pathway in the polymer elastomer. That is, metallic particles or carbon black particles must closely make contact with each other such that electrons can move along the conductive particles. For instance, when carbon black is mixed with urethane resin for obtaining electrical conductivity, 15 to 30 weight percent of carbon black is used with respect to the urethane resin. In order to obtain superior electrical conductivity, more than 40 weight percent of carbon black is used. However, in these cases, not only is it difficult to uniformly distribute particles of carbon black, but also melt viscoelasticity of urethane resin is reduced, so that filler particles may cohere with each other, thereby significantly increasing viscosity. As a result, foaming is impossible and the specific gravity of the product is increased while deteriorating the properties of the product, so that the impact and vibration absorbing property of the product may be degraded. Meanwhile, when the metallic powder is used, it is necessary to increase the amount of the metallic powder by two to three times as compared with a case of carbon black in order to obtain electrical conductivity. In this case, the dispersion characteristic of the metallic powder is deteriorated and the specific gravity of the mixture is increased.

As mentioned above, the amount of conductive materials must be limited due to the difficulty of the manufacturing process and the property degradation of the product. For this reason, relatively great volume resistance is presented, so that it is difficult to obtain desired vertical volume conductivity. As a result, according to the conventional method of mixing conductive filler with polymer resin, it is difficult to obtain the polymeric elastomer, the electromagnetic wave shielding material, or the electromagnetic wave shielding gasket having superior conductivity as well as impact and vibration absorbing properties.

Another conventional method is to add a great amount (more than 70 weight percent) of fillers to a silicon sheet, thereby allowing the silicon sheet to have conductivity. However, this conventional method excessively uses the fillers, so the fabrication cost may increase. Examples of conventional methods for imparting conductivity into the polymer resin or the polymeric elastomer are disclosed in Japanese Patent Unexamined Publication Nos. 9-000816 and 2000-077891 and U.S. Pat. Nos. 6,768,524, 6,784,363 and 4,548,862.

In addition, since the conventional conductive elastomer has no adhesive properties, if a gasket made from the conventional conductive elastomer is applied to the electronic appliance, the gasket may not be easily fixed to the electronic appliance before the product is assembled. For this reason, adhesive must be separately applied to the conductive elastomer or an adhesive tape, such as a double-sided adhesive tape, must be used in order to fix the conductive elastomer to the electronic appliance.

That is, a gasket having impact and vibration absorbing properties and volume conductivity with high elasticity, low hardness and low permanent compression set has not been yet developed. In addition, a gasket having the self-adhesive property has not been yet developed.

### SUMMARY OF THE INVENTION

In order to solve the above problems occurring in the prior art, inventors of the present invention have performed research and studies so as to impart surface conductivity and volume conductivity into a polymeric elastomer having the adhesive property such that the polymeric elastomer can be used as a material for an electromagnetic wave shielding gasket.

As a result, inventors of the present invention have developed a method capable of imparting conductivity into adhesive polymer resin in both longitudinal and transverse directions of the adhesive polymer resin. If such adhesive polymer resin is used as a material for a gasket, it is possible to simply obtain an electromagnetic wave shielding gasket having impact and vibration absorbing characteristics with desired surface conductivity and volume conductivity without degrading the properties of the gasket.

Accordingly, an object of the present invention is to provide an electromagnetic wave shielding gasket, which can be simply fabricated and has impact and vibration absorbing characteristics and the adhesive property with desired surface conductivity and volume conductivity without degrading the property of the gasket.

Another object of the present invention is to provide a method for fabricating the above gasket.

In order to accomplish the above objects, according to one aspect of the present invention, there is provided a gasket having elastic and adhesive properties as well as electromagnetic wave shielding functions.

In detail, the gasket includes an electroconductive substrate; and an adhesive polymer sheet having electrical conductivity and being aligned on the electroconductive substrate, wherein the adhesive polymer sheet includes adhesive polymer resin and conductive fillers distributed in the adhesive polymer resin, and the conductive fillers are aligned in both longitudinal and transverse directions in the adhesive polymer resin while being electrically connected with each other over a whole area of the adhesive polymer sheet.

According to another aspect of the present invention, there is provided a method for fabricating the gasket. In detail, the present invention provides a method for fabricating an electroconductive gasket having elastic and adhesive properties and including an electroconductive substrate and an adhesive polymer sheet having electrical conductivity and being aligned on the electroconductive substrate, the method comprising the steps of: preparing a mixture by mixing a monomer for forming adhesive polymer resin with conductive fillers; fabricating the mixture in a form of a sheet; aligning a mask having a masking pattern at both surfaces of the sheet and photopolymerizing the adhesive polymer resin by irradiating light onto the sheet through the mask, thereby fabricating the adhesive polymer sheet in which the conductive fillers are aligned in both longitudinal and transverse directions of the adhesive polymer resin while being electrically connected over a whole area of the sheet; and aligning the adhesive polymer sheet onto one surface of the electroconductive substrate.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a schematic view showing fillers aligned in an adhesive polymer sheet according to one embodiment of the present invention;

FIG. 2a is a photographic view showing an adhesive polymer sheet used as a maternal for a gasket according to one embodiment of the present invention;

FIG. 2b is a photographic view taken by an SEM (scanning electron microscope), which shows a sectional shape of an adhesive polymer sheet and fillers aligned therein according to one embodiment of the present invention;

FIG. 2c is a photographic view taken by an SEM, which shows an upper surface of an adhesive polymer sheet and fillers aligned therein according to one embodiment of the present invention;

FIG. 3a is a photographic view showing an adhesive polymer sheet employing fibrous conductive fillers according to another embodiment of the present invention;

FIG. 3b is a photographic view taken by an SEM, which shows a sectional shape of an adhesive polymer sheet according to another embodiment of the present invention;

FIG. 3c is a photographic view taken by an SEM, which shows an upper surface of an adhesive polymer sheet and fillers aligned in the adhesive polymer sheet while being exposed to an exterior according to another embodiment of the present invention;

FIG. 4 is a schematic view showing a release sheet pattern according to one embodiment of the present invention;

FIGS. 5a and 5b are schematic views showing the alignment of fillers being changed upon the light irradiation according to one embodiment of the present invention;

FIG. 6a is a schematic view showing the process including the steps of preparing an adhesive polymer sheet, combining the same with an electroconductive substrate, and winding the resultant structure in the form of a gasket;

FIG. 6b is a schematic view showing a gasket wound according to the process shown in FIG. 6a;

FIG. 7a is a schematic view showing the structure of a gasket according to one embodiment of the present invention, in which the gasket includes an electroconductive substrate formed with an adhesive polymer sheet;

FIG. 7b is a schematic view showing the structure of a gasket according to another embodiment of the present invention, in which the gasket includes an electroconductive substrate formed with an adhesive polymer sheet and a release sheet disposed on the adhesive polymer sheet;

FIG. 8a is a schematic view showing the process of manufacturing a conductive mesh film;

FIG. 8b is a schematic view showing the process of manufacturing a gasket using the conductive mesh film; and

FIG. 9 shows a cross-sectional view of the gasket manufactured by using the conductive mesh film.

### DETAILED DESCRIPTION OF THE INVENTION

Reference will now be made in detail to the preferred embodiments of the present invention.

A gasket according to the present invention includes an electroconductive substrate 600 and an adhesive polymer sheet 100 having the electrical conductivity and being aligned on the electroconductive substrate 600. Since the electroconductive substrate 600 has conductivity in both longitudinal 140 and transverse 130 directions thereof, it is possible to provide a gasket having conductivity in both transverse 130 and longitudinal 140 directions thereof.

In the gasket according to the present invention, the electroconductive substrate 600 supports an adhesive polymer sheet 100 and has a thickness of about 0.02 to 1 mm.

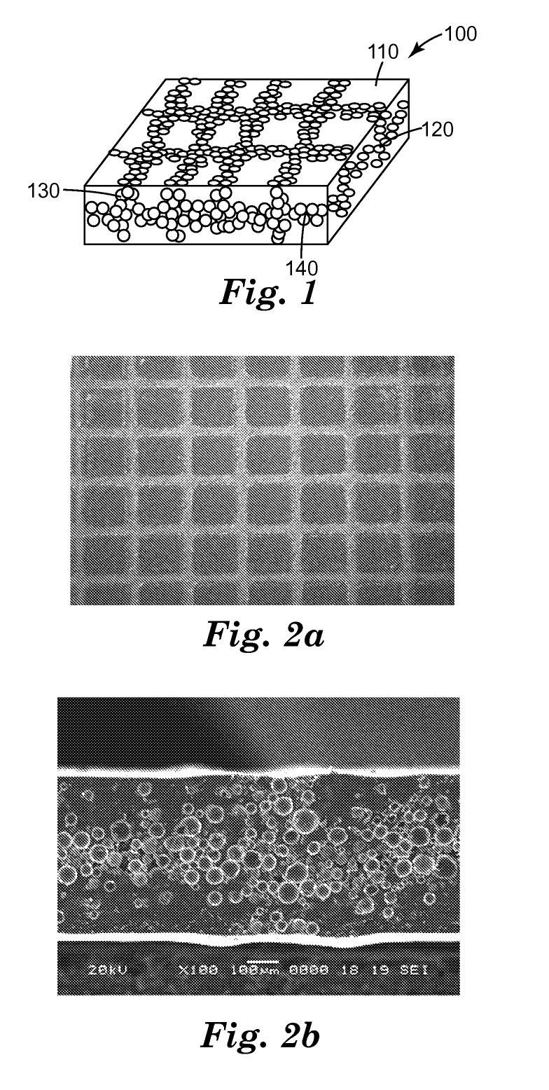

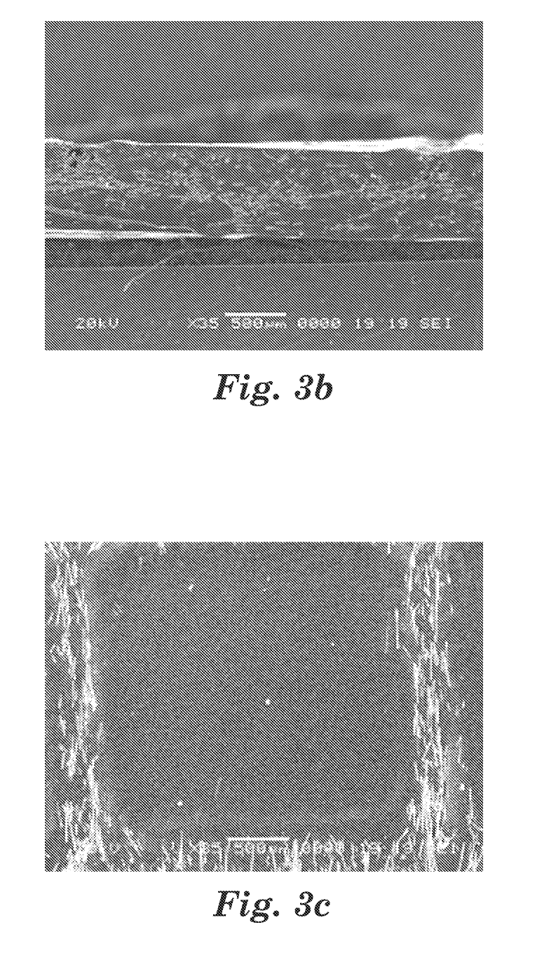

The adhesive polymer sheet 100 imparts adhesive and elastic properties as well as electrical conductivity into the gasket of the present invention such that the gasket has an electromagnetic wave shielding function. Some of fillers 120 contained in the adhesive polymer sheet 100 are aligned in the longitudinal 140 direction of the adhesive polymer sheet 100. That is, as shown in FIGS. 1 to 4b, some of fillers 120 are aligned in a z-axis direction, so cracking may occur in the z-axis direction in the adhesive polymer sheet 100. In this case, the elasticity of the adhesive polymer sheet 100 is reduced, so that the elasticity of the gasket is also reduced, thereby degrading the impact absorbing function of the gasket. For this reason, the adhesive polymer sheet 100 is aligned on the electroconductive substrate 600 in order to prevent cracking.

The electroconductive substrate 600 has a flexible thin sheet structure and is preferably made from a material having the electrical conductivity. Although the present invention does not specially limit the type of electroconductive substrates 600, the electroconductive substrate 600 may include one selected from the group consisting of conductive fabrics, conductive non-woven fabrics, conductivity-treated fabrics, conductivity-treated non-woven fabrics, metal foils and metal films.

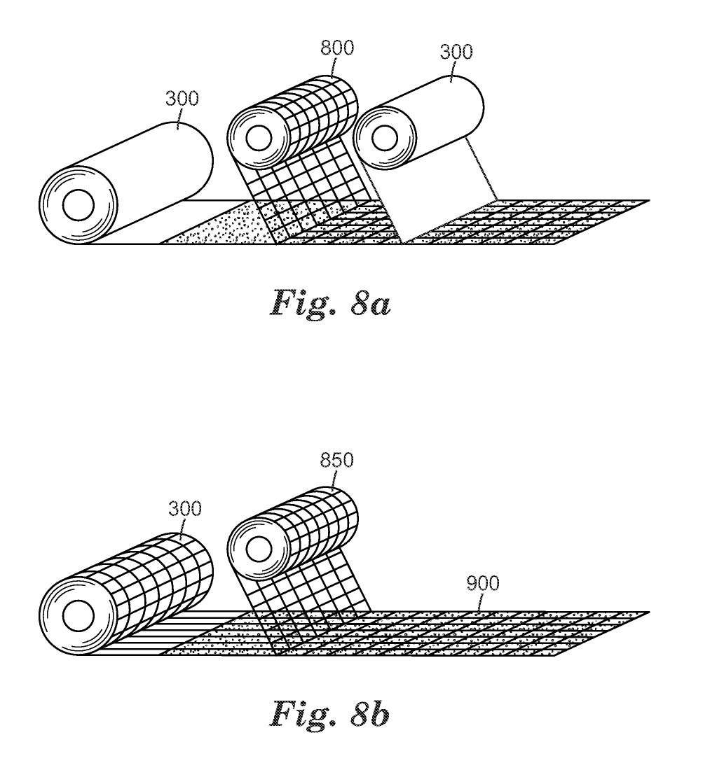

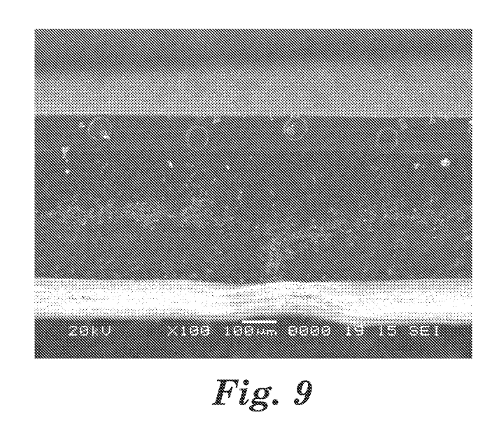

In one embodiment of the present invention, as an electroconductive substrate 600, a conductive mesh 800 film 850 that can function as a masking pattern 310 may be used. The conductive mesh 800 film 850 can be prepared by coating a conductive mesh 800 with polymer resin (see FIG. 8a). In the conductive mesh 800 film 850, the conductive mesh 800 does not pass light 450 therethrough and thus can function as a masking pattern 310; and because the conductive mesh 800 has conductivity it can function as a electroconductive substrate 600. That is, the conductive mesh 800 film 850 selectively shields light 450 passing through to make selective photopolymerization, however the conductive mesh 800 film 850 is not removed after photopolymerization, but is incorporated into the adhesive polymer sheet 100 to form a gasket.

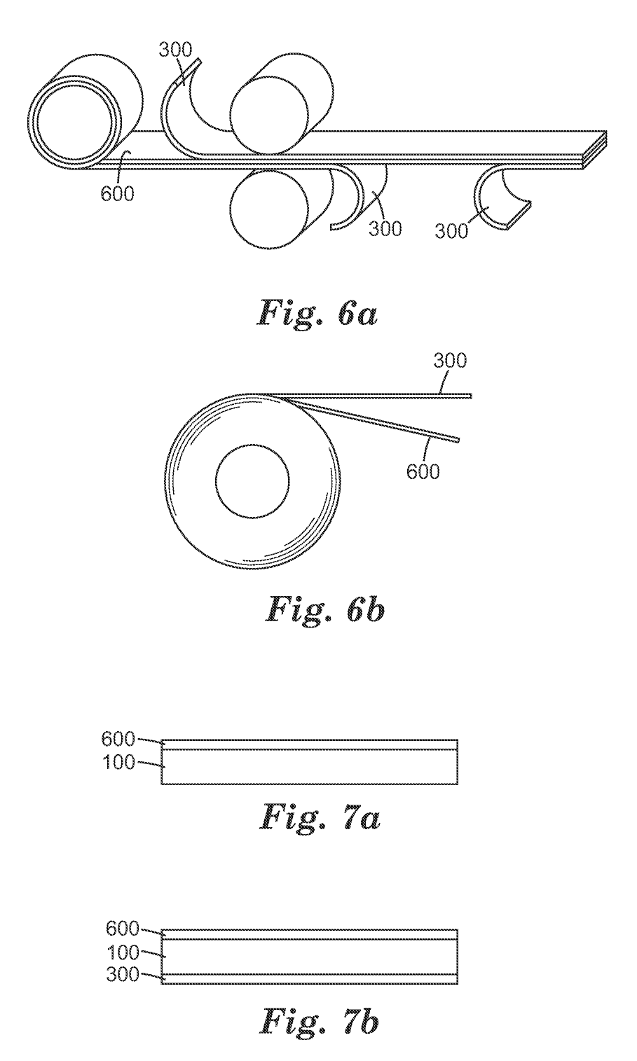

Release coating can be applied to one surface of the electroconductive substrate 600 where the adhesive polymer sheet 100 is not formed. That is, the adhesive polymer sheet 100 is provided on the other surface of the electroconductive substrate 600 where the release coating is not applied. Thus, as shown in FIG. 6a, the gasket including the electroconductive substrate 600 and the adhesive polymer sheet 100 aligned on the electroconductive substrate 600 can be manufactured in the form of a roll. Since release coating is applied to one surface of the electroconductive substrate 600, the gasket manufactured in the form of the roll can be easily released due to the release coating surface.

In one exemplary embodiment of the present invention, a release sheet 300 can be laminated on one surface of the adhesive polymer sheet 100, which does not make contact with the electroconductive substrate 600 (see, FIG. 7b). The gasket combined with the release sheet 300 is stored in the form the roll when it is not used. If it is necessary to use the gasket, the release sheet 300 is removed from the gasket, so that the gasket can be applied to objects or products.

In another exemplary embodiment of the present invention, two-trip process may be applied. That is, a product can be made in a state that release sheets 300 are laminated on both surfaces of the adhesive polymer sheet 100, and when needed, an electroconductive substrate 600 may be laminated on one surface of the adhesive polymer sheet 100 after removing the release sheet 300.

According to the gasket of the present invention, the adhesive polymer sheet 100 includes adhesive polymer resin and conductive fillers 120 distributed on a surface and in an inner portion of the adhesive polymer resin. The conductive fillers 120 are aligned in both transverse 130 (x-y plane) and longitudinal 140 (z-axis direction) directions of the adhesive polymer sheet 100 while making electrical contact with each other, thereby forming a conductive network over the whole area of the adhesive polymer sheet 100, so the adhesive polymer sheet 100 may have electrical conductivity in both transverse 130 and longitudinal 140 directions thereof. In this manner, the conductive fillers 120 form the conductive network in the adhesive polymer resin (see, FIGS. 1, 2b, 3b and 5b).

For example, acryl-based polymer may be used as a polymeric component for the adhesive polymer resin. In particular, photopolymerizable acryl polymer, which can be obtained through photopolymerization, can be used as a polymeric component for the adhesive polymer resin. The conductive fillers 120 are aligned in the horizontal and vertical directions in the adhesive polymer resin. In order to achieve such alignment, photopolymerizable acryl polymer is preferably used because mobility of the conductive fillers 120 can be ensured in the process of photopolymerization.

According to one embodiment of the present invention, polymer obtained by polymerizing photopolymerizable monomer can be used as a polymeric component for the adhesive polymer resin. The photopolymerizable monomer includes alkyl acrylate monomer having C1 to C14 alkyl group.

The alkyl acrylate monomer includes, but not exclusively, butyl (meth)acrylate, hexyl (meth)acrylate, n-octyl (meth)acrylate, isooctyl (meth)acrylate, 2-ethyl-hexyl (meth)acrylate, or isononyl (meth)acrylate. In addition, the alkyl acrylate monomer also includes isooctyl acrylate, isononyl acrylate, 2-ethyl-hexyl acrylate, decyl acrylate, dodecyl acrylate, n-butyl acrylate, or hexyl acrylate.

Although the alkyl acrylate monomer can be solely used, the alkyl acrylate monomer is generally co-polymerized with co-polymerizable monomer having the polarity different from that of the alkyl acrylate monomer in order to form the adhesive polymer resin.

At this time, a ratio of the alkyl acrylate monomer to the co-polymerizable monomer having the above polarity is not specially limited. For instance, a weight ratio of 99-50:1-50 can be adopted. The co-polymerizable monomer having the above polarity is classified into co-polymerizable monomer having storing polarity and co-polymerizable monomer having normal polarity. The ratio of the co-polymerizable monomer to the alkyl acrylate monomer may vary depending on the polarity thereof.

The co-polymerizable monomer having the above polarity includes, but not exclusively, acrylic acid, itaconic acid, hydroxyalkyl acrylate, cyanoalkyl acrylate, acrylamide, or substituted acrylamide. In addition, co-polymerizable monomer having polarity lower than that of the above components includes N-vinyl pyrrolidone, N-vinyl caprolactam, acrylonitrile, vinyl chloride, or diallyl phthalate.

The co-polymerizable monomer having the above polarity imparts adhesive and coherent properties into the polymer resin while improving adhesion of the polymer resin.

The conductive fillers 120 used for imparting electrical conductivity into the adhesive polymer sheet 100 according to the present invention are aligned in the horizontal and vertical directions of the adhesive polymer resin while forming the conductive network in such a manner that the current may flow through the conductive network. The alignment of the conductive fillers 120 is shown in FIGS. 1 and 5b.

According to one embodiment of the present invention, the contents of the conductive fillers 120 are 5 to 500 parts by weight based on 100 parts by weight of the adhesive polymer resin. According to another embodiment of the present invention, the contents of the conductive fillers 120 are 20 to 150 parts by weight based on 100 parts by weight of the adhesive polymer resin.

There is no particular limitation in kind of the conductive filler, and any conductive filler that can impart electroconductivity can be used.

The conductive filler that may be used includes noble metals; non-noble metals; noble metal-plated noble or non-noble metals; non-noble metal-plated noble and non-noble metals; noble or non-noble metal plated non-metals; conductive non-metals; conductive polymers; and mixtures thereof. More particularly, the conductive filler that may include noble metals such as gold, silver, platinum; non-noble metals such as nickel, copper, tin, aluminum, and nickel; noble metal-plated noble or non-noble metals such as silver-plated copper, nickel, aluminum, tin, or gold; non-noble metal-plated noble and non-noble metals such as nickel-plated copper or silver; noble or non-noble metal plated non-metals such as silver or nickel-plated graphite, glass, ceramics, plastics, elastomers, or mica; conductive non-metals such as carbon black or carbon fiber; conductive polymers such as polyacetylene, polyaniline, polypyrrole, polythiophene, poly sulfurnitride, poly(p-phenylene), poly(phenylene sulfide) or poly(p-phenylenevinylene); and mixtures thereof.

The filler is broadly classified as “particulate” in form, although the particular shape of such form is not considered critical to the present invention, and may include any shape that is conventionally involved in the manufacture or formulation of conductive materials of the type herein involved including hollow or solid microspheres, elastomeric balloons, flakes, platelets, fibers, rods, irregularly-shaped particles, or a mixture thereof.

Similarly, the particle size of the filler is not considered critical, and may be or a narrow or broad distribution or range, but in one exemplary embodiment of the present invention will be between about 0.250-250 μm, and in another exemplary embodiment between about 1-100 μm.

In particular, when the gasket is applied to a metallic case, rather than a plastic case, the nickel-coated metals are preferably used as the conductive fillers 120. For example, nickel-coated graphite fiber is used as the conductive fillers 120. Different from the plastic case, corrosion may occur at a contact surface between the metallic case and the conductive fillers 120. Such corrosion is called “Galvanic corrosion”, which is caused when two metals having different properties make contact with each other and oxidation of one metal is promoted by the other metal. Galvanic corrosion is also called “hetero-metal contact corrosion” and corrosion may occur at a high speed if different types of metals make contact with each other. For instance, if an aluminum pipe is connected with a copper pipe in water, since aluminum has a relatively lower electrode potential for oxidation and reduction, the surface of the aluminum pipe is easily corroded. In contrast, since copper has a relatively low over-potential at a surface thereof with respect to reduction of hydrogen ions, copper assists the corrosion of aluminum. However, nickel is stable against the Galvanic corrosion, so nickel-coated fillers are preferably used in order to prevent the Galvanic corrosion.

Meanwhile, fibrous fillers have fine thread shapes, so that when the fibrous fillers are aligned on the adhesive polymer sheet 100 in a horizontal direction, that is, when the fibrous fillers are aligned on an x-y plane of the adhesive polymer sheet 100, degradation of elasticity and flexibility of the adhesive polymer sheet 100 caused by the fillers can be minimized.

Thus, according to one embodiment of the present invention, nickel-coated graphite fiber or nickel particle with filament type is preferably used as the conductive fillers 120. Preferably, the nickel-coated graphite fiber or the nickel particle with filament type has a length of about 10 to 200 μm, and a thickness of about 5 to 20 μm.

In order to obtain the property adaptable for the gasket, the adhesive polymer sheet 100 may include at least one type of other fillers. The present invention may not specially limit the type of other fillers, if it does not exert bad influence upon the characteristics and utility of the adhesive polymer sheet 100. For instance, other fillers include, but not exclusively, heat conductive fillers, flame-resistant fillers, anti-static agents, foaming agents or polymer hollow microspheres.

According to the present invention, the contents of the other fillers 120 are 100 parts by weight based on 100 parts by weight of polymer components. In addition, the adhesive polymer sheet 100 may include other additives, such as polymerization initiators, cross-linking agents, photo-initiators, pigments, anti-oxidants, UV-stabilizers, dispersants, defoaming agents, thickening agents, plasticizers, tackifying resins, silane coupling agents or glazing agents.

According to the gasket of the present invention, properties of the adhesive polymer sheet 100, in particular, the adhesive property of the adhesive polymer sheet 100 can be adjusted depending on the amount of the cross-linking agents. According to one embodiment of the present invention, the contents of the cross-linking agents are 0.05 to 2 parts by weight based on 100 parts by weight of the adhesive polymer resin. The cross-linking agents include multi-functional acrylate, such as 1,6-hexanediol diacrylate, trimethylopropane triacrylate, pentaerythritol triacrylate, 1,2-ethylene glycol diacrylate, or 1,12-dodecanediol acrylate. However, the present invention is not limited thereto.

In addition, the photo-initiator can be used when fabricating the adhesive polymer sheet 100. The polymerization degree of the adhesive polymer resin can be adjusted depending on the amount of the photo-initiators. According to one embodiment of the present invention, the contents of the photo-initiators are 0.01 to 2 parts by weight based on 100 parts by weight of the adhesive polymer resin. The photo-initiators available in the present invention include 2,4,6-trimethylbenzoyldiphenyl phosphineoxide, bis(2,4,6-trimethylbenzoyl)phenylphosphineoxide, α,α-methoxy-α-hydroxyacetophenone, 2-benzoyl-2(dimethyl amino)-1-[4-(4-morphonyl)phenyl]-1-butanone, or 2,2-dimethoxy 2-phenyl acetophenone. However, the present invention is not limited thereto.

According to one embodiment of the present invention, the gasket can be obtained by laminating the adhesive polymer sheet 100 onto an electroconductive substrate 600, and, the adhesive polymer sheet 100 can be fabricated through the above mentioned monomer polymerization. In detail, the monomer for forming adhesive polymer resin is mixed with conductive fillers 120 for imparting conductivity, and then fillers or additives are added thereto if necessary. After that, the above components are polymerized thereby forming the adhesive polymer resin.

According to another embodiment of the present invention, the gasket can be obtained by using a conductive mesh 800 film 850 that can function as a masking pattern 310 as electroconductive substrate 600, to incorporate the conductive mesh 800 film 850 into the adhesive polymer sheet 100 during photopolymerization, thus forming a gasket with a single step.

According to an embodiment of the present invention, there is provided a method for fabricating an electroconductive gasket having elastic and adhesive properties including an electroconductive substrate 600 and an adhesive polymer sheet 100 having electrical conductivity formed on the electroconductive substrate 600. In detail, the method comprising the steps of:

preparing a mixture by mixing a monomer for forming adhesive polymer resin with conductive fillers 120;

fabricating the mixture in the form of a sheet;

aligning a mask having a masking pattern 310 at both surfaces of the sheet and photopolymerizing the adhesive polymer resin by irradiating light 450 onto the sheet through the mask, thereby fabricating an adhesive polymer sheet 100 in which the conductive fillers 120 are aligned in longitudinal 140 and horizontal 130 directions of the adhesive polymer resin while being electrically connected over the whole area of the sheet; and

laminating the adhesive polymer sheet 100 onto one surface of the electroconductive substrate 600.

The method may further comprise a step of adding polymerization initiators or cross-linking agents.

In order to allow the adhesive polymer sheet 100 to have conductivity in both transverse 130 and longitudinal 140 directions thereof, mobility of the fillers 120 can be utilized during the polymerization process. In detail, photopolymerization can be adopted in order to utilize the mobility of the fillers 120.

To this end, according to the present invention, after mixing the monomer for forming adhesive polymer resin with conductive fillers 120, photopolymerization is performed by irradiating light 450 onto the mixture. At this time, the light 450 is locally irradiated onto the surface of the mixture. According to the above method, the conductive fillers 120 can be added after partially polymerizing the monomer for forming the adhesive polymer resin in such a manner that the conductive fillers 120 can be uniformly dispersed in the component used for fabricating the polymer resin.

According to an embodiment of the present invention, in order to facilitate dispersion of the conductive fillers 120 and initiation of selective photopolymerization, the monomer for forming the adhesive polymer resin is preliminarily polymerized in the form of photopolymerizable polymer syrup 110, and then conductive fillers 120 and other additives are added to the photopolymerizable polymer syrup 110. After that, the above components are uniformly stirred and then polymerization and cross-linking processes are performed.

Therefore, according to an embodiment of the present invention, an adhesive polymer sheet 100 is fabricated through a method comprising the steps of:

forming polymer syrup 110 by partially polymerizing a monomer used for forming polymer;

adding conductive fillers 120 to the polymer syrup 110 and uniformly mixing the mixture;

aligning a mask having a predetermined masking pattern 310 on a surface of the polymer syrup 110 mixed with the conductive fillers 120; and

irradiating light 450 onto the polymer syrup 110 through the mask, thereby photopolymerizing the polymer syrup 110. Then, the adhesive polymer sheet 100 fabricated through the above method is coated on an electroconductive substrate 600, thereby obtaining a gasket.

In this manner, the adhesive polymer sheet 100 formed with a conductive filler network can be fabricated, and then the gasket can be fabricated by using the adhesive polymer sheet 100.

The polymer syrup 110 obtained through the partial polymerization process has viscosity of about 500 to 20,000 cPs, which is adaptable for the next photopolymerization process. In addition, a thixotropic material, such as silica, can be employed if necessary, in order to sufficiently thicken the monomers such that the monomers can be formed as syrups.

Preferably, the adhesive polymer sheet 100 is fabricated under the oxygen-free condition. In addition, UV light 450 is irradiated during the photopolymerization process.

For instance, the oxygen-free condition includes an oxygen-free chamber where density of oxygen is less than 1000 ppm. That is, after aligning the mask, the light 450 is irradiated onto the polymer syrup 110 in the oxygen-free chamber where density of oxygen is less than 1000 ppm. In order to provide the strict oxygen-free condition, it is possible to adjust the density of oxygen less than 500 ppm in the oxygen-free chamber. In addition, release sheets 300 can be aligned on both sides of the syrup in order to substantially shield oxygen. In this case, it is not necessary to use oxygen-free chamber.

In addition, if the masking pattern 310 is directly formed on the release sheet 300, it is not necessary to use the mask. In this case, the release sheet 300 serves as the mask having the masking pattern 310.

According to the present invention, in order to allow the adhesive polymer sheet 100 to have conductivity in both transverse 130 and longitudinal 140 directions thereof, mobility of the fillers 120 can be utilized during the polymerization process. In detail, when performing the photopolymerization process by irradiating light 450 onto syrup-state polymer component after adding conductive fillers 120 to the syrup-state polymer component (hereinafter, referred to as polymer syrup 110), in which monomers have not yet been completely cured, the light 450 is selectively irradiated onto the surface of the polymer syrup 110 in such a manner that photopolymerization is selectively initiated at the surface of the polymer syrup 110, thereby aligning the conductive fillers 120 in a desired pattern.

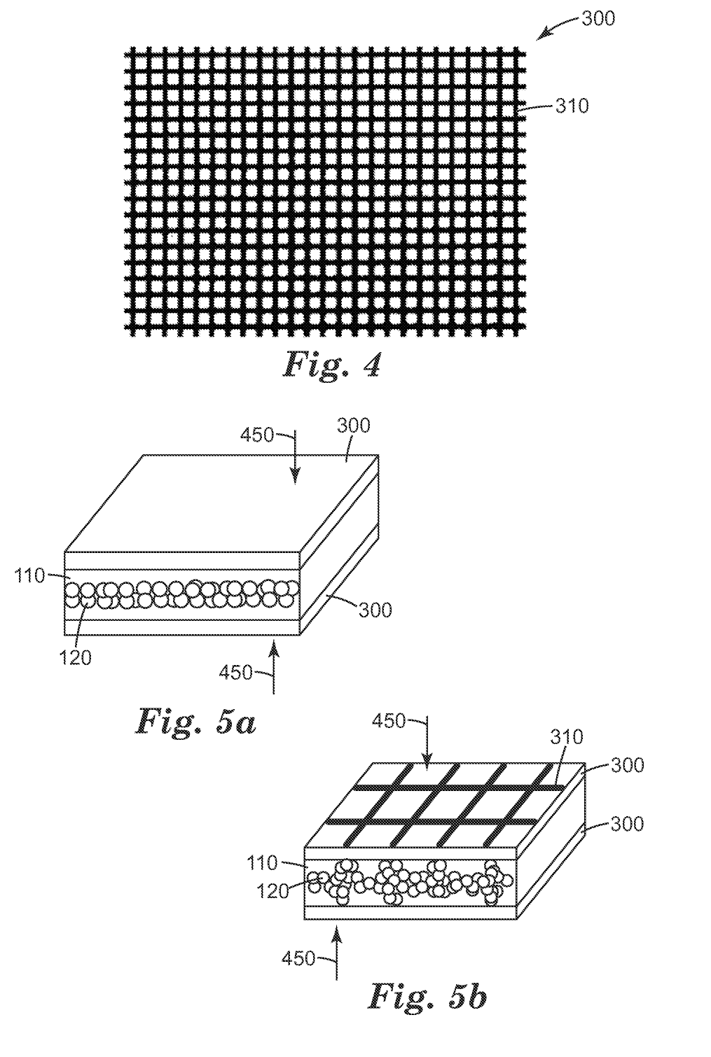

The mask having the predetermined masking pattern 310 can be used for the purpose of selective polymerization. The mask having the predetermined masking pattern 310 includes a light-passing area for allowing the light 450 to pass therethrough and a light-shielding area for shielding or reducing the light 450 passing therethrough. The mask may include, but not exclusively, a release sheet 300 having a predetermined masking pattern 310, a mesh net, a mesh, or a lattice. According to an embodiment of the present invention, the release sheet 300 having the predetermined masking pattern 310 as shown in FIG. 4 is preferably used as the mask.

The release sheet 300 is made from a lightweight permeable material and is formed with the masking pattern 310 (see, FIG. 4) having a light-passing area for allowing the light 450 to pass therethrough and a light-shielding area for shielding or reducing the light 450 passing therethrough. The release sheet 300 can be aligned on both surfaces of sheet-type polymer syrup 110. In this case, the release sheet 300 may serve as an oxygen barrier. The masking pattern 310 formed in the mask may substantially reduce the amount of light 450 passing through the mask or shield the light 450, so the photopolymerization speed is significantly dropped or photopolymerization is not initiated at the surface of the polymer syrup 110 below the mask.

Although the release sheet 300 is preferably made from the lightweight permeable material, it is also possible to fabricate the release sheet 300 using transparent plastic treated with release coating or having lower surface energy. For instance, the release sheet 300 can be fabricated using a polyethylene film, a polypropylene film or a polyethylene terephthalate (PET) film.

The present invention does not specially limit the thickness of the release sheet 300. According to an embodiment of the present invention, the release sheet 300 having the thickness of about 5 μm to 2 mm is used. If the thickness of the release sheet 300 is less than 5 μm, the thickness of the release sheet 300 is too thin to form the masking pattern 310 and to coat the polymer syrup 110 on the release sheet 300. In contrast, if the thickness of the release sheet 300 exceeds 2 mm, photopolymerization for the polymer syrup 110 is very difficult.

The present invention may not specially limit the method for forming the masking pattern 310 on the release sheet 300 if the method includes the step of aligning a material having characteristics of reducing or shielding the light 450 passing therethrough on a surface of a lightweight permeable material. For instance, a printing method can be utilized. The printing method includes typical printing methods, such as, a screen printing method, a printing method using a heat transfer paper, or a gravure printing method. In addition, black ink having superior light absorbing properties can be used in the above printing methods.

Due to the above masking pattern 310, the light 450 cannot pass through the release sheet 300 or the amount of light 450 passing through the release sheet 300 may be significantly reduced, so the photopolymerization is not initiated or reduced at the surface of the release sheet 300 below the masking pattern 310 and the photopolymerization speed is lowered (see, FIG. 5b). However, photopolymerization may actively occur at an area aligned beside the masking pattern 310 while creating the radical. As a result, polymerization may proceed in the downward direction from the masking pattern 310. At this time, due to selective photopolymerization, the conductive fillers 120 remaining in an area where the polymerization is initiated are shifted into an area where the polymerization is not yet initiated.

In detail, during the process of selective photopolymerization, polymerization is initiated from an area where the masking pattern 310 is not formed, so the conductive fillers 120 remaining in the above area are shifted into an area where polymerization is not yet initiated (see, FIG. 5a). In contrast, since polymerization is not initiated in the area formed below the masking pattern 310, conductive fillers 120 remaining in the above area are not shifted (see, FIG. 5b). Accordingly, as shown in FIG. 1, the conductive fillers 120 are concentrated in the transverse 130 direction (x-y plane) of the adhesive polymer sheet 100 at an area where the masking pattern 310 is not formed and are concentrated in the longitudinal 140 direction (z-axis direction) of the adhesive polymer sheet 100 at an area where the masking pattern 310 is formed, thereby forming the conductive network over the whole area of the adhesive polymer sheet 100. As a result, the adhesive polymer sheet 100 has conductivity in both transverse 130 and longitudinal 140 directions thereof by means of the conductive fillers 120.

That is, the conductive fillers 120 are aligned in the longitudinal 140 direction (z-axis direction) of the adhesive polymer sheet 100 at the area where the masking pattern 310 is formed and are aligned in the transverse 130 direction (x-y plane) of the adhesive polymer sheet 100 at the area where the masking pattern 310 is not formed, thereby forming the conductive network in the longitudinal 140 and transverse 130 directions of the adhesive polymer sheet 100. Thus, polymer resin according to the present invention may have electrical conductivity in the longitudinal 140 direction thereof, so it has superior conductivity as compared with conventional polymer resin in which the conductive fillers 120 are irregularly aligned therein.

The present invention does not specially limit the type of masking patterns 310 formed in the release sheet 300. According to an embodiment of the present invention, a light shielding section formed by the masking pattern 310 may occupy 1 to 70% of the release sheet 300. If an area of the light shielding section is less than 1% of the release sheet 300, the conductive fillers 120 cannot be efficiently aligned in the longitudinal 140 direction. In contrast, if an area of the light shielding section exceeds 70% of the release sheet 300, it may interrupt photopolymerization.

In addition, the present invention does not specially limit the thickness of the adhesive polymer sheet 100 used for the gasket. For instance, the adhesive polymer sheet 100 may have the thickness of about 25 μm to 3 mm by taking photopolymerization and mobility of the conductive fillers 120 into consideration. If the thickness of the adhesive polymer sheet 100 is less than 25 μm, workability may be degraded due to the thin thickness of the adhesive polymer sheet 100. In contrast, if the thickness of the adhesive polymer sheet 100 exceeds 3 mm, it may interrupt photopolymerization.

The light 450 has intensity adaptable for typical photopolymerization. According to an embodiment of the present invention, the light 450 has intensity identical to that of UV light 450. In addition, light 450 irradiation time may be changed depending on the light intensity during the photopolymerization process.

According to an embodiment of the present invention, in order to improve flexibility of the gasket, the adhesive polymer sheet 100 can be fabricated through the foaming process. The foaming process includes various foaming schemes, such as mechanical distribution of foams by injecting gaseous foaming agent, dispersion of hollow polymer microspheres, or use of thermal foaming agent.

The foaming agent includes, but not exclusively, water; volatile organic compounds such as propane, n-butane, isobutane, butylene, isobutene, pentane, or hexane; and inert gases such as nitrogen, argon, xenon, krypton, helium, or CO₂. In addition, the foaming agent may include chlorofluorocarbons (CFCs) and hydrochlorofluorocarbons (HDFCs), but they may cause ozone depletion.

According to an embodiment of the present invention, after fabricating the adhesive polymer sheet 100, the adhesive polymer sheet 100 is coated or laminated onto the electroconductive substrate 600, thereby obtaining the gasket. Such coating work or laminating work for the adhesive polymer sheet 100 can be performed in a manner as shown in FIG. 6a. That is, between the release sheets 300 aligned at both surfaces of the adhesive polymer sheet 100, the release sheet 300 aligned on one surface of the adhesive polymer sheet 100 is removed. At the same time, the electroconductive substrate 600 is formed on the one surface of the adhesive polymer sheet 100 where the release sheet 300 has been removed. In addition, while removing the release sheet 300 aligned at the other surface of the adhesive polymer sheet 100, the adhesive polymer sheet 100 formed with the electroconductive substrate 600 is wound around a roll, thereby fabricating the gasket, which is available from market.

In another embodiment of the present invention, two-trip process may be applied. That is, a commercial product can be made in a state that release sheets 300 are laminated on both surfaces of the adhesive polymer sheet 100, and when needed by the user, an electroconductive substrate 600 may be laminated on one surface of the adhesive polymer sheet 100 after removing the release sheet 300.

In addition, a gasket can be obtained by using a conductive mesh 800 film 850 that can function as a masking pattern 310 and an electroconductive substrate 600. In this case, a gasket is prepared in a single step of photopolymerization incorporating the conductive mesh 800 film 850 into the adhesive polymer sheet 100. In the above gasket, the conductive mesh 800 film 850 is the electroconductive substrate 600.

The conductive mesh 800 film 850 can be prepared by coating a conductive mesh 800 with polymer resin. In the conductive mesh 800 film 850, the conductive mesh 800 does not pass light 450 therethrough and thus can function as a masking pattern 310; and because the conductive mesh 800 has conductivity it can function as an electroconductive substrate 600.

FIG. 8a shows the process of manufacturing the conductive mesh 800 film 850.

According to one embodiment shown in FIG. 8a, conductive mesh 800 is placed on a release liner 300, a syrup type polymer resin is applied thereon to coat the conductive mesh 800, then a release liner 300 is laminated thereon, and the syrup type polymer resin is cured to form a conductive mesh 800 film 850. In this case, it is preferred that the mesh is exposed on the surface by controlling the coating thickness.

Thickness of the conductive mesh 800 film 850 is not limited, but a thickness may be about 5 μm-2 mm according to one embodiment of the present invention, and the thickness may be about 20 μm-1 mm according to another embodiment of the present invention.

After preparing the conductive mesh 800 film 850, a release liner 300 on one surface is removed and adhesive polymer syrup 110 containing conductive filler is coated thereon and a release liner 300 with masking pattern 310 is laminated on the surface of the polymer syrup 110, then photopolymerization is performed to form a gasket with electroconductive substrate 600 being incorporated into the adhesive polymer sheet 100 (see FIG. 8b). FIG. 9 shows a cross-sectional view of the above prepared gasket.

The gasket according to the present invention has adhesive and conductive properties as well as elasticity without using a separate member and can be fabricated in the form of a roll. In addition, the gasket has superior conductivity in the longitudinal 140 direction thereof, so the gasket has superior electromagnetic wave shielding functions.

That is, the gasket according to the present invention has elasticity, so it can protect electronic communication appliances from external impact or vibration. In addition, since the gasket according to the present invention has superior electrical conductivity, it can simultaneously shield various electronic waves and electromagnetic waves generated from the electronic communication appliances, thereby improving the function and performance of the electronic communication appliances. In particular, the gasket according to the present invention is adaptable for display units, such as LCD devices and PDP devices, and mobile instrument, such as mobile phones and mobile game devices.

Hereinafter, the present invention will be described in detail with reference to embodiments, comparative examples and experimental examples, which are for illustrative purposes only and are not intended to limit the scope of the present invention.

In the following description, the term “parts” refers to “parts by weight” based on 100 parts by weight of the adhesive polymer resin obtained through polymerization.

### Embodiment 1

93 parts of 2-ethyle hexyl acrylate, which is acrylic monomer, 7 parts of acrylic acid, which is polar monomer, and 0.04 parts of Irgacure-651 (α,α-methoxy-α-hydroxyacetophenone), which is photoinitiator, are partially polymerized in a glass reactor having a volume of 1 l, thereby obtaining 3000 cPs syrup. In addition, 100 parts of cPs syrup are mixed with 0.1 part of Irgacure-819 [Bis(2,4,6-trimethylbenzoyl)phenylphosphineoxide], which is photoinitiator, and 0.65 parts of 1,6-hexanediol diacrylate (HDDA), which is cross-linking agent, and the mixture is sufficiently stirred. Then, 30 parts of silver coated hollow glass sphere (SH230S33, Potters Industries Inc.) having a particle size of 44 μm are mixed with the mixture as electroconductive fillers, and then the mixture is sufficiently stirred, thereby obtaining the mixture in the form of polymer syrup.

Meanwhile, as shown in FIG. 4, the lattice having a width of 700 μm and an interval of 1.5 mm is patterned on a transparent polypropylene film having the thickness of 75 μm using black ink, thereby obtaining the release sheet.

Then, the polymer syrup is extruded from the glass reactor and the release sheets are aligned on both surfaces of the polymer syrup using a roll coating device such that the polymer syrup can be positioned between the release sheets with the thickness of about 0.5 mm. Since the release sheets are aligned on both surfaces of the polymer syrup, the polymer syrup is prevented from making contact with air, especially, oxygen.

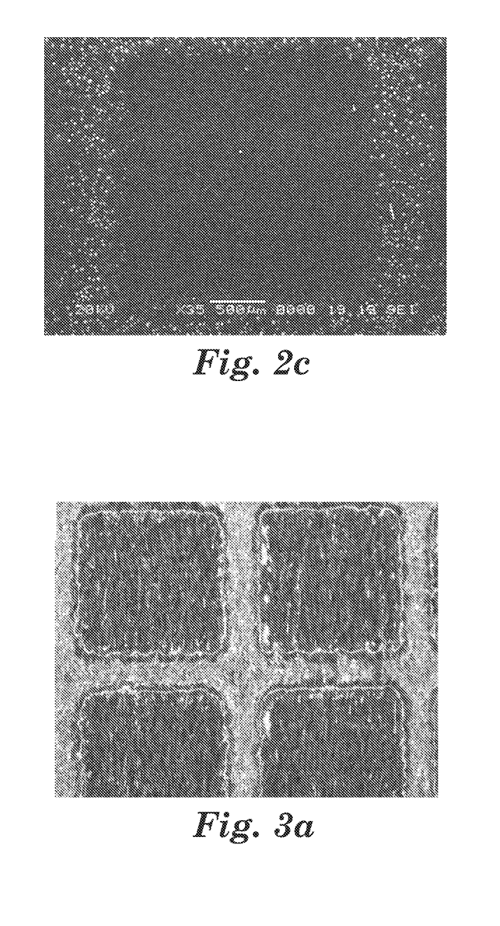

After that, UV light having the intensity of 5.16 mw/cm² is irradiated onto both surfaces of the polymer syrup from a metal halide UV lamp for 520 seconds, thereby obtaining the adhesive polymer sheet. FIGS. 2a to 2c are photographic views taken by an SEM (scanning electron microscope), which show the sectional shape and the upper surface of the adhesive polymer sheet fabricated through Embodiment 1. As shown in FIGS. 2a to 2c, the conductive fillers are aligned in the transverse direction (x-y plane) of the adhesive polymer sheet at an area where the masking pattern is not formed and are aligned in the longitudinal direction (z-axis direction) of the adhesive polymer sheet at an area where the masking pattern is formed, thereby forming the conductive network over the whole area (the x-y direction and z-direction) of the adhesive polymer sheet.

Then, after fabricating the adhesive polymer sheet, the adhesive polymer sheet is coated on the electroconductive substrate. Ni/Cu coated pet fabric having the thickness of 60 μm is used as the electroconductive substrate for the gasket. During the coating process, as shown in FIG. 6a, the release sheet aligned on one surface of the adhesive polymer sheet is removed. At the same time, the electroconductive substrate is aligned on the one surface of the adhesive polymer sheet where the release sheet has been removed. After that, while removing the release sheet formed on the other surface of the adhesive polymer sheet, the adhesive polymer sheet formed with the electroconductive substrate is wound around a roll, thereby forming the gasket.

### Embodiment 2

Embodiment 2 is performed in the same manner as Embodiment 1, except that 60 parts of Ni-coated graphite fiber available from Sulzer Metco Inc. are used as conductive fillers in order to fabricate the gasket. FIGS. 6a to 6c are photographic views taken by an SEM (scanning electron microscope), which show the sectional shape and the upper surface of the adhesive polymer sheet fabricated through Embodiment 2.

### Embodiment 3

Embodiment 3 is performed in the same manner as Embodiment 2, except that Ni/Cu coated conductive fabric is used as an electroconductive substrate in order to fabricate the gasket.

### Comparative Examples 1 to 3

Comparative Examples 1 to 3 are performed in the same manner as Embodiments 1 to 3 in order to fabricate the gasket, except that the masking pattern is not formed on the release sheet in the UV light irradiation step.

### Comparative Example 4

Comparative Example 4 is performed in the same manner as Embodiment 2 in order to fabricate the gasket, except that the electroconductive substrate is not used.

### Experimental Example 1

### Resistance Measurement

Volume resistance of the gasket fabricated through Embodiments 1 and 2 and Comparative Examples 1 and 2 is measured according to the surface probe scheme of MIL-G-83528B (Standard) by using Kiethely 580 micro-ohmmeter. The result is shown in Table 1.

### Experimental Example 2

### Adhesion Force Test

After laminating aluminum onto the gasket fabricated through the above Embodiments and Comparative Examples, adhesion force for steel in the direction of 90° is measured. Variation of the adhesion force is measured at the temperatures of 25° C. and 100° C., respectively, after more than 30 minutes has lapsed. The result is shown in Table 1.

TABLE 1

| | | | | Comp. | Comp. |
|---|---|---|---|---|---|
| | | Embd. 1 | Embd. 2 | Example 1 | Example 1 |
| Volume Resistance | | 0.04 | 0.07 | Out of | Out of |
| (Ohm) | | | | measurement | measurement |
| Adhesion | 25° C. | 1065 | 975 | 1219 | 991 |
| force(gf/in) | 100° C. | 2457 | 2111 | 2643 | 2313 |

As shown in Table 1, the gasket fabricated according to the Embodiments of the present invention presents adhesion force identical to or similar to that of the gasket fabricated according to Comparative Examples, while representing superior conductivity. That is, the Comparative Examples represent the volume resistance out of the measurement range, but the Embodiments of the present invention can significantly reduce the volume resistance.

### Experimental Example 3

### Tensile Strength

Tensile strength of the gasket fabricated according to Embodiments 1 to 3 and Comparative Examples 1 to 4 is measured using a tensile strength tester. The result is shown in Table 2.

TABLE 2

| | | | | Comp. | Comp. | Comp. | Comp. |
|---|---|---|---|---|---|---|---|
| | Embd. 1 | Embd. 2 | Embd. 3 | Example 1 | Example 2 | Example 3 | Example 4 |
| Tensile | 8.1 kgf | 6.8 kgf | 7.1 kgf | 0.4 kgf | 0.4 kgf | 0.45 kgf | 0.41 kgf |
| strength | | | | | | | |

As shown in Table 2, the gasket fabricated according to Embodiments of the present invention represents superior tensile strength as compared with the gasket fabricated according to Comparative Examples.

As described above, the gasket according to the present invention includes the adhesive polymer sheet having conductive fillers aligned on the electroconductive substrate, in which the conductive fillers are aligned in the longitudinal direction as well as the transverse direction of the adhesive polymer sheet, so the gasket has superior conductivity in the longitudinal direction thereof. As a result, the gasket according to the present invention represents superior impact and vibration absorbing properties and electromagnetic wave shielding function. Thus, when the gasket of the present invention is used as a packing for an electronic appliance, the gasket can effectively protect the electronic components installed in the electronic appliance. In addition, the gasket has the self-adhesive property, so the gasket can be easily used for assembling various parts of the electronic appliance.

1-29. (canceled)

30. A gasket comprising:
an electroconductive substrate; and
an adhesive polymer sheet having electrical conductivity and being aligned on the electroconductive substrate, wherein
the adhesive polymer sheet includes adhesive polymer resin and conductive fillers distributed in the adhesive polymer resin, and
the conductive fillers are aligned in both longitudinal and transverse directions in the adhesive polymer resin while being electrically connected with each other over a whole area of the adhesive polymer sheet.

31. The gasket of claim 30, wherein the adhesive polymer sheet has a thickness of about 25 μm to 3 mm.

32. The gasket of claim 30, wherein the electroconductive substrate has a thickness of about 0.2 to 1 mm.

33. The gasket of claim 30, wherein the electroconductive substrate includes one selected from the group consisting of conductive fabrics, conductive non-woven fabrics, conductivity-treated fabrics, conductivity-treated non-woven fabrics, metal foils, metal films and conductive mesh film manufactured by coating a conductive mesh with a polymer resin.

34. The gasket of claim 30, wherein a surface of the electroconductive substrate, in which the adhesive polymer sheet is not aligned, is treated with release coating.

35. The gasket of claim 30, wherein amount of the conductive fillers ranges from 5 to 500 parts by weight based on 100 parts by weight of the adhesive polymer resin.

36. The gasket as claimed in claim 1, wherein the conductive fillers include acrylic polymer resin, optionally wherein the acrylic polymer resin includes a polymer obtained by co-polymerizing an alkyl acrylate monomer having a C1 to C14 alkyl group with a polar copolymerizable monomer.

37. The gasket of claim 36, wherein the alkyl acrylate monomer includes one selected from butyl (meth)acrylate, hexyl (meth)acrylate, n-octyl (meth)acrylate, isooctyl (meth)acrylate, 2-ethyl-hexyl (meth)acrylate, isononyl (meth)acrylate, isooctyl acrylate, isononyl acrylate, 2-ethyl-hexyl acrylate, decyl acrylate, dodecyl acrylate, n-butyl acrylate, and hexyl acrylate.

38. The gasket of claim 36, wherein the polar copolymerizable monomer includes one selected from acrylic acid, itaconic acid, hydroxyalkyl acrylate, cyanoalkyl acrylate, acrylamide, substituted acrylamide, N-vinyl pyrrolidone, N-vinyl caprolactam, acrylonitrile, vinyl chloride, and diallyl phthalate.

39. The gasket as claimed in claim 36, wherein a weight ratio between the alkyl acrylate monomer and the polar copolymerizable monomer is 99-50:1-50.

40. The gasket of claim 30, wherein the conductive filler is selected from noble metals; non-noble metals; noble metal-plated noble or non-noble metals; non-noble metal-plated noble and non-noble metals; noble or non-noble metal plated non-metals; conductive non-metals; conductive polymers; and mixtures thereof.

41. The gasket as claimed in claim 40, wherein
the noble metals include gold, silver, platinum,
the non-noble metals include nickel, copper, tin, aluminum, and nickel;
the noble metal-plated noble or non-noble metals include silver-plated copper, nickel, aluminum, tin, and gold;
the non-noble metal-plated noble and non-noble metals include nickel-plated copper and silver;
the noble or non-noble metal plated non-metals include silver or nickel-plated graphite, glass, ceramics, plastics, elastomers, and mica;
the conductive non-metals include carbon black and carbon fiber; and
conductive polymers include polyacetylene, polyaniline, polypyrrole, polythiophene poly sulfurnitride poly(p-phenylene), poly(phenylene sulfide) and poly(p-phenylenevinylene).

42. The gasket of claim 30, wherein the conductive fillers include nickel-coated graphite fiber and nickel particles, wherein the fibers have a length of about 10 to 200 μm and a thickness of about 5 to 20 μm.

43. The gasket of claim 30, wherein the electroconductive substrate is a conductive mesh film, and the conductive mesh film is incorporated into the adhesive polymer sheet.

44. A method for fabricating a gasket including an electroconductive substrate and an adhesive polymer sheet having electrical conductivity and being aligned on the electroconductive substrate, the method comprising:
preparing a mixture by mixing a monomer for forming adhesive polymer resin with conductive fillers;
fabricating the mixture in a form of a sheet;
aligning a mask having a masking pattern at both surfaces of the sheet and photopolymerizing the adhesive polymer resin by irradiating light onto the sheet through the mask, thereby fabricating the adhesive polymer sheet in which the conductive fillers are aligned in both longitudinal and transverse directions of the adhesive polymer resin while being electrically connected; and
providing the adhesive polymer sheet on one surface of the electroconductive substrate.

45. The method of claim 44, wherein mixing the monomer with the conductive fillers includes:
forming polymer syrup by partially polymerizing the monomer for the adhesive polymer resin; and
adding the conductive fillers to the polymer syrup obtained by partially polymerizing the monomer.

46. The method of claim 44, wherein light is irradiated onto the mixture under a condition where the amount of oxygen is less than 1000 ppm.

47. The method of claim 44, wherein the mask has a masking pattern that includes a mesh net, a lattice, a release sheet having a predetermined masking pattern or a conductive mesh film with a polymeric coating.

48. A method for fabricating a gasket including an electroconductive substrate and an adhesive polymer sheet having electrical conductivity and being aligned on the electroconductive substrate, the method comprising:
forming polymer syrup by partially polymerizing a monomer for forming adhesive polymer resin;
adding conductive fillers to the polymer syrup and uniformly mixing the mixture;
planarizing the polymer syrup having the conductive fillers in a form of a tape sheet and aligning a mask having a masking pattern on a surface of the polymer syrup;
irradiating light onto the surface of the polymer syrup through the mask such that the adhesive polymer resin is photopolymerized, thereby fabricating the adhesive polymer sheet, in which the conductive fillers are aligned in both longitudinal and transverse directions of the adhesive polymer resin while being electrically connected over a whole area of the adhesive polymer sheet; and
coating the adhesive polymer sheet onto one surface of the electroconductive substrate.
